(19) United States
(12) Patent Application Publication
(10) Pub. No.: US 2008/0272104 A1
(43) Pub. Date: Nov. 6, 2008

(54) Heated handle construction

(76) Inventor: Robyn J. Farrington, Westfield, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 12/154,187

(22) Filed: May 21, 2008

Related U.S. Application Data
(63) Continuation-in-part of application No. 11/983,017, filed on Nov. 5, 2007, now abandoned.
Application No. 11/983,017 is a continuation-in-part of application No. 11/839,859, filed on Aug. 16, 2007.
Application No. 11/839,859 is a continuation-in-part of application No. 11/800,390, filed on May 4, 2007.

(51) Int. Cl. H05B 3/02

(52) U.S. Cl. 219/201

(57) ABSTRACT

A heated handle construction for integration and/or detachable mounting on an umbrella, cane, walker, crutches, wheelchair, snow shovel, baby stroller, golf club, hockey stick, animal lead/leash, knitting needle and crochet hook has an integral stem portion constructed with a handle portion, a central shaft, and a bearing member. The handle has an outer show surface and is composed of a thermally insulating material, wound with wrapped flexible heating tape or strip, and connected through an on-off switch to a plurality of batteries present in a hollow cavity of the central shaft. Optionally, a thermally insulating foam tape is inserted between the heating element and the thermally insulating handle. An infrared reflector placed below the heating element directs heat to the user's hand. The heating element raises the temperature of the handle, radiating heat to the hand of the user, thereby providing a comfortable grip during use in wintry weather. The handle is, optionally, adapted to interchangeably mount on more than one device.

### RELATED U.S. APPLICATION DATA

This application is a continuation-in-part of co-pending U.S. patent application Ser. No. 11/983,017, filed Nov. 7, 2007 which, in turn, is a continuation-in-part of co-pending U.S. patent application Ser. No. 11/839,859, filed Aug. 17, 2007 which, in turn, is a continuation-in-part of co-pending U.S. patent application Ser. No. 11/800,390, filed May 4, 2007, the entire disclosures of which are incorporated herein by reference thereto as if being set forth in their entirety.

### BACKGROUND OF THE INVENTION

1. Field of the Invention

The present invention relates to hand warming apparatus associated with handles of implements and devices appointed for low-temperature use; and more particularly, to one or more devices appointed with a handle portion, which may be detachable and interchangeable, having heating elements integrated therein that is constructed from a thermally insulating material, and has an outer show layer to warm the handle appointed to be held, gripped or otherwise in contact with a hand of a user. The hand warming apparatus has particular application for use in the construction of umbrellas, canes, walkers, walking sticks, crutches, wheelchairs, snow shovels, baby carriages, strollers, golf clubs, hockey sticks, animal leads, pet leashes, sporting equipment and knitting needles and crochet hooks.

2. Description of the Prior Art

The handles and/or arm rests of umbrellas, canes, walkers, walking sticks, crutches, wheelchairs, snow shovels, baby carriages, strollers, golf clubs, hockey sticks, animal leads, pet leashes, knitting needles and crochet hooks are generally the first element contacted when the device is placed in service. Oftentimes, and particularly during the winter months, these handles become cold and uncomfortable to touch, or to grip for an appreciable period of time. Many patents address issues related to warming handles of various devices, such as fishing rods, ski poles, motorcycle handles, and the like. These patents do not address warming the handles of umbrellas, canes, walkers, walking sticks, crutches, wheelchairs, snow shovels, baby carriages, strollers, golf clubs, hockey sticks, animal leads, pet leashes, and knitting needles and crochet hooks using self-contained electrical power accessed through a user-operated switch.

Various devices have been provided that disclose heated fishing rods.

U.S. Pat. No. 744,789 to Fliess discloses a heated fishing rod including a handle heated by electrical wires powered by an external battery; however the polished porcelain surface of the fishing rod handle is not a metal, and does not reflect infrared radiation. Moreover, power is supplied from batteries, which are not contained within the fishing rod or its handle.

U.S. Pat. No. 3,164,921 to Mavrakis discloses a heated fishing rod wherein fishing line guides are heated by battery power to prevent ice freezing over the fishing line. A plurality of rods through which the fishing line is passed is heated by battery power. Though the heated rods pass through the handle, the thick insulation of the handle substantially prevents any of the heat from reaching the hand of the user.

U.S. Pat. No. 4,598,192 to Garrett discloses an electrically heated handle for a fishing rod and teaches a conductive aluminum shell contacting the hand of the fisherman with an insulating Steatite body is inserted within the aluminum thermally conductive shell. A heating coil, powered by an external battery, is wound in a pair of passages on the outer surface of the insulating Steatite body. The coil first heats the insulating Steatite body, which is a poor conductor. Heat and thermal contact between the aluminum shell and the insulating Steatite body raises the temperature of the aluminum shell handle. Due to the insulating character of the Steatite body, the handle stays warm for a long time, even when the heating coil is switched off. Since the heating coil is in very close proximity with the aluminum shell, the coil has a tendency to become short circuited thereby. Due to the poor heat conduction character of the Steatite body, the heating coil may overheat and burn out. At any rate, the heating of the insulating body is very slow, with the result that heat delivery to the hand is not robust. The fishing rod handle disclosed by the '192 patent would not be suitable for umbrellas, canes, walkers, walking sticks, crutches, wheelchairs, snow shovels, baby carriages, strollers, golf clubs, hockey sticks, animal leads, pet leashes, and knitting needles and crochet hooks. Moreover, the battery for heating the heating coil is external and is not contained within the handle.

U.S. Pat. No. 5,517,786 to Peissig discloses a heated fishing rod having of a foam handle, plastic cylinder, plastic coated heat tape, rechargeable battery pack, on/off toggle button, electronic regulator, reel holder, metal housed ceramic eyes, and tapered rod shaft. Within the foam handle is a plastic cylinder that houses the battery pack and fixtures for electrical contacts. The rechargeable batteries in the handle heat the fishing rod at the handle and at the ceramic eyelets, providing heat to the hand and to the ceramic eyelets for easy movement of the fishing line, when turned on by a switch. The heat is provided by a plastic coated heating tape that is wrapped in the required locations. The process by which the electrical circuit heats the wrapped tape is unclear. The device disclosed by the '786 patent is a heated fishing rod. No disclosure is contained there in concerning heated handles for umbrellas, canes, walkers, walking sticks, crutches, wheelchairs, snow shovels, baby carriages, strollers, golf clubs, hockey sticks, animal leads, pet leashes, and knitting needles and crochet hooks.

Other heated devices disclosed by prior art workers include heated umbrellas; but these umbrella devices are not equipped with heated handles. U.S. Pat. No. 1,683,270 to Taylor et al. discloses a radiation receiving conductor via an umbrella having a wound coil receiving electromagnetic radio waves. U.S. Pat. No. 2,496,501 to Staunton et al. discloses an umbrella wherein the cover of the umbrella has a novel, inexpensive, folding structure. U.S. Pat. No. 2,757,679 to Rivkin et al. discloses an emergency umbrella having a small number of parts and a water repellant canopy. These heated umbrella devices do not suggest use of a heated handle for umbrellas, canes, walkers, walking sticks, crutches, wheelchairs, snow shovels, baby carriages, strollers, golf clubs, hockey sticks, animal leads, pet leashes, and knitting needles and/or crochet hooks.

Additionally, U.S. Pat. No. 3,739,792 to Holland discloses an umbrella with heat generating means. Electric heating elements located in ribs of the umbrella framework heat the volume of air present under the umbrella canopy. Electrical heaters in the vertical column are powered by a plurality of batteries contained within the vertical column or carried elsewhere in a pocket or briefcase. The heating elements in the vertical column heat the surrounding air, which rises upwards. The heaters do not therefore warm the handle of the umbrella at the local where the user's hands make contact therewith, and does not provide a heated handle for umbrellas, canes, walkers, walking sticks, crutches, wheelchairs, snow shovels, baby carriages, strollers, golf clubs, hockey sticks, animal leads, pet leashes, and knitting needles and/or crochet hooks.

U.S. Pat. No. 4,978,110 to Lin et al. discloses a fire protection umbrella having an asbestos cloth covered with a flame retardant paint, and with ceramic tiles or hollow tubes. An umbrella cover is connected to strong umbrella ribs fashioned to function as a parachute. The handle of the fire retardant umbrella is not heated.

U.S. Pat. No. 5,625,960 to Fujita discloses a unit for removing rainwater from umbrellas including an umbrella insertion portion into which an umbrella that is wet with rain is inserted via a plurality of brushes and forced air circulation. This disclosure does not contemplate an umbrella having a heated handle, let alone means for heating handles of umbrellas, canes, walkers, walking sticks, crutches, wheelchairs, snow shovels, baby carriages, strollers, golf clubs, hockey sticks, animal leads, pet leashes, and knitting needles and/or crochet hooks.

U.S. Pat. No. 5,823,212 to Allen discloses a stadium umbrella having a cover composed of a transparent, as opposed to an opaque, material. Coverage is provided for the torso of the user. The umbrella comprises a transparent cover through which the user can see a sports event. A motor driving a wiper for the umbrella is powered by batteries contained in the umbrella's handle or shaft. The handle of the umbrella is not heated. Batteries in the umbrella shaft drive the wiper motor; but do not supply power to a handle heater. A heated handle integrated into umbrellas, canes, walkers, walking sticks, crutches, wheelchairs, snow shovels, baby carriages, strollers, golf clubs, hockey sticks, animal leads, pet leashes, and knitting needles and/or crochet hooks is not disclosed.

U.S. Pat. No. 7,003,217 to Bachinski et al. discloses an infrared heating system for patio umbrellas wherein a plurality of infrared heaters are mounted on the cross support members, and additionally on the support stand, provide infrared heat to the users under the umbrella. The handle of the umbrella is not heated, and the reference does not provide heated handles for umbrellas, canes, walkers, walking sticks, crutches, wheelchairs, snow shovels, baby carriages, strollers, golf clubs, hockey sticks, animal leads, pet leashes, and knitting needles and/or crochet hooks.

Foreign Patent Publication No EP1504689 to Bowyer et al. discloses an umbrella adapted to incorporate a heater attached to the ribs of the umbrella and heats the users within the canopy of the umbrella, however the handle of the umbrella is not provided with a heater and this disclosure does not disclose a heated handle in umbrellas, canes, walkers, walking sticks, crutches, wheelchairs, snow shovels, baby carriages, strollers, golf clubs, hockey sticks, animal leads, pet leashes, and knitting needles and/or crochet hooks.

Foreign Patent Publication No JP4067802 to Naonori discloses an umbrella handle containing a heating element that releases heat during oxidation. An airtight bag contains the product subject to oxidation. An air hole is opened to allow oxidation to occur and thus cause heat production. This bag, containing an oxidizable product, forms a separate element and is therefore not integral with the umbrella. The handle of the umbrella is not heated by electrical wires or strip, and a heated handle for umbrellas, canes, walkers, walking sticks, crutches, wheelchairs, snow shovels, baby carriages, strollers, golf clubs, hockey sticks, animal leads, pet leashes, and knitting needles and/or crochet hooks.

Further heated devices provided deal with heated hand grips for motorcycles, golf clubs and other apparatuses. These heated hand grips do not provide a heated handle integrated within umbrellas, canes, walkers, walking sticks, crutches, wheelchairs, snow shovels, baby carriages, strollers, golf clubs, hockey sticks, animal leads, pet leashes, and knitting needles and/or crochet hooks.

U.S. Pat. No. 5,834,734 to Ogata discloses a handgrip with built-in heater. A cylindrical rubber handgrip body is connected to a handle bar pipe of, for example, a motor cycle. The rubber handgrip is slid over the handlebar of the motorcycle. A heating element is embedded in the rubber handgrip and is powered by an external battery, which constitutes the battery in the motorcycle. The handgrip with the built in heater is not integral to the motorcycle handle; but is instead slid-on over the handlebar. The '734 patented device is not used to heat the handles of umbrellas, canes, walkers, walking sticks, crutches, wheelchairs, snow shovels, baby carriages, strollers, golf clubs, hockey sticks, animal leads, pet leashes, and knitting needles and/or crochet hooks. Other similar motorcycle slip-on handle heaters are disclosed by U.S. Pat. Nos. 5,735,037, 5,626,780 and 5,613,407.

U.S. Pat. No. 6,998,576 to Marquis discloses an electrically heated hand grip that is suited for handles of sports apparatus such as a golf club. An electrically heated hand grip, primarily for golf clubs, is slipped over the golf club so that the inner sleeve member bonds and is attached to the golf club by an adhesive. This requires the inner sleeve member to be straight and the golf club to have a straight cylindrical character. Such a device is not useful for handles of canes, walkers, walking sticks, snow shovels, baby carriages and strollers, which generally have a curved configuration. The heated hand grip is a separate device that is slipped onto a golf club by being inserted over a golf club handle and bonded thereto by adhesive. The heated hand grip does not provide a heated handle integrated within a umbrellas, canes, walkers, walking sticks, crutches, wheelchairs, snow shovels, baby carriages, strollers, golf clubs, hockey sticks, animal leads, pet leashes, and knitting needles and/or crochet hooks.

U.S. Pat. No. 7,119,304 to Meyers discloses a heated handgrip. This rechargeable, reusable heated hand grip is designed for use on a ski pole, shovel or other cold weather hand-held tool or object. This heated hand grip constitutes a separate assembly with batteries, a switch and a heating element that surrounds a central core and is placed within an outer casing. The heated handgrip is attached to a ski pole by use of a bushing that is attached to the top of the ski pole by setscrews. The heated hand grip is slid on the bushing, securing it to the ski pole. This sliding action requires that the ski pole, or other device to which the heated handgrip is attached, be straight; not curved. On the other hand, handles of umbrellas, canes, walkers, walking sticks, crutches, wheelchairs, snow shovels, baby carriages, strollers, golf clubs, hockey sticks, animal leads, pet leashes, and knitting needles and/or crochet hooks, are generally not straight; but are, instead, have curved segments. Consequently, a hand grip heater of the type disclosed by the '304 patent, cannot be slid-on and secured to the curvilinear handles.

Additional heated devices disclosed by prior art workers utilize portable heaters and various ceramic heaters. These heated devices do not suggest a heated handle integrated within a cane, walker, walking stick, baby carriage and stroller, and/or snow shovel.

U.S. Pat. No. 4,210,073 to Weiss discloses a portable environmental chamber. This environmental chamber is in the form of a dome that covers food and has an internal electrical heater that keeps the food warm. The '073 patent does not disclose or suggest a umbrellas, canes, walkers, walking sticks, crutches, wheelchairs, snow shovels, baby carriages, strollers, golf clubs, hockey sticks, animal leads, pet leashes, and knitting needles and/or crochet hooks having a heated handle integrated therein.

Foreign Patent Publication No JP6203947 to Tsumoru discloses a ceramic heater. This ceramic heater is a carbon based heater wherein conductive carbon powder is perfectly or partially covered over an insulating ceramic inner part. Such a structure forms a general purpose ceramic heater. The '947 patent does not disclose a heater in the handle of a umbrellas, canes, walkers, walking sticks, crutches, wheelchairs, snow shovels, baby carriages, strollers, golf clubs, hockey sticks, animal leads, pet leashes, and knitting needles and/or crochet hooks.

There remains a need in the art for a heated handle integrated within or detachable from umbrellas, canes, walkers, walking sticks, crutches, wheelchairs, snow shovels, baby carriages, strollers, golf clubs, hockey sticks, animal leads, pet leashes, and knitting needles and/or crochet hooks. Also needed is a heated handle construction that can be interchanged on a variety of devices, such as interchanged between an umbrella and cane. Further needed in the art is a heated handle construction detachable or attached for walking sticks, crutches, wheelchairs, snow shovels, baby carriages, strollers, golf clubs, hockey sticks, animal leads, pet leashes, and knitting needles and/or crochet hooks having integrated therein a heated handle and/or arm rest that can readily be switched on by the user to prevent hand contact with a cold handle thereof; and which will maintain a warm temperature on the user's hand during use in cold weather.

### SUMMARY OF THE INVENTION

The present invention provides a heated handle construction that is utilized with umbrellas, canes, walkers, walking sticks, crutches, wheelchairs, snow shovels, baby carriages, strollers, golf clubs, hockey sticks, animal leads, pet leashes, and knitting needles and/or crochet hooks. The heated handle utilized in these particular devices can readily be switched on in advance of use to prevent hand contact with a cold handle before a warmer handle temperature is achieved. Warmth is maintained on the user's hands and arms (where applicable, as with a wheelchair) while the user is walking in low-temperature environments, such as those encountered during fall and winter. Moreover, the warming effect on the user's hands provides comfort and relieves pain otherwise encountered by individuals with arthritic hands and joints. In one embodiment, the handle is detachable from the device. In another embodiment along the same lines, the handle is interchangeable on a plurality of devices, such as a first device being an umbrella and a second device being a cane or walking stick.

Broadly stated, the heated handle construction may include an integral stem portion integrated within a first device having a distal end, central shaft and a proximal end. The proximal end is appointed to engage with a handle portion. A bearing member/terminal member may be located on the distal end, depending on the apparatus type of the first device. A retaining chamber is provided for housing a power source therein. The handle portion is constructed from a thermally insulating material and has an outer layer, which is the show layer or contact interface for the user's hand. Further, the handle portion is wrapped with integral heating elements to adjust the handle to a comfortable temperature level. The power source is electrically connected to the heating element through an on-off switch, and provides energy for powering the heating element. In operation, the handle is warmed efficiently to raise the handle to a temperature level that provides a comfortable grip for the user. The retaining chamber may be located in the central shaft of an integral stem portion of the device, or alternatively the retaining chamber housing the power source may be integrated within the handle portion itself.

The heated handle construction has particular application for use in the assembly of umbrellas, canes, walkers, walking sticks, crutches, wheelchairs, snow shovels, baby carriages, strollers, golf clubs, hockey sticks, animal leads, pet leashes, and knitting needles and crochet hooks. As a result, the umbrella, cane, walker, walking stick, crutches, wheelchair, snow shovel, baby carriage, stroller, golf club, hockey stick, animal lead, pet leash, and knitting needle and/or crochet hook provides a heated handle that is warm to the touch even during use at low temperatures when walking or working in wintry or drafty weather. The handle may be detachable from the first device.

Further provided is a heated handle construction for mounting on at least one device, comprising a thermally insulating material, an outer layer, and integral heating elements appointed to adjust the handle to a temperature level. A retaining chamber for housing a power source is provided in communication with an on-off switch for delivering power to the heating elements. Included is a mounting means for removable attachment of handle to a proximal end of an integral stem portion of a first device. The device's stem portion further comprises a distal end and a central shaft, with the proximal end including a handle attachment means appointed for mating engagement with the mounting means of the handle for mounting the handle on the integral stem portion. Thus, the handle is attached to the first device by way of the mounting means and is warmed efficiently to raise the handle to a temperature level that provides a comfortable grip for the user of the first device. Preferably, the first device is an umbrella having a heated handle construction, wherein the integral stem portion further includes a canopy portion, a spring member and a plurality of extension rods. The canopy has an external surface and an internal surface, and the external surface of the canopy is water repellent and thereby resists saturation and shedding or facilitating the repellency of rain drops. The water repellent canopy prevents accumulation of water on the heated handle and the heated handle is warmed efficiently to provide the comfortable grip for said user. The handle is be detachable from the first device; and may be provided as a system wherein it can be attached to more than one device by simply removing the handle portion from the first device and attaching same to a second device, thus yielding an interchangeable heated handle construction having application in a variety of weather conditions or situations.

### BRIEF DESCRIPTION OF DRAWINGS

The invention will be more fully understood and further advantages will become apparent when reference is had to the following detailed description and the accompanying drawings, in which:

FIG. 1 is a cross-sectional side view of a walking stick or cane with an embodiment of the heated handle construction integrated therein, illustrating the details of the heater arrangement in the handle and showing the outer layer covering of the handle and optional external covering of the stem shaft and the retaining chamber housing the power source, shown as batteries, optionally in the stem shaft;

FIG. 1.1 illustrates the details of an insulating ceramic, wood or polymeric material of a handle wrapped with heating elements;

FIG. 1.2 illustrates placement of an insulating foam material between the insulating handle and the wrapped heating elements;

FIG. 1.3 illustrates placement of an infrared reflective foil or membrane between the heating element and the insulating foam material;

FIG. 1.4 illustrates an on-off switch with selectable heat delivery control;

FIG. 2a illustrates an embodiment of the heated handle construction wherein the handle is interchangeable between multiple devices, and wherein the power source's retaining chamber is optionally integrated within each device;

FIG. 2b illustrates the heated handle construction of FIG. 2a wherein the handle is mounted onto the first device, shown as a cane/walking stick;

FIG. 2c illustrates the heated handle construction of FIG. 2a wherein the handle is mounted onto the second device, shown as an umbrella;

FIG. 3 illustrates an embodiment of the heated handle construction wherein the handle is interchangeable between multiple devices, and wherein the handle comprises an internal compartment forming the retaining chamber for housing the power source, shown as batteries, so that the power source/batteries are retained within the handle;

FIG. 4a illustrates another embodiment of the heated handle construction wherein the handle, detachable or undetachable, comprises an internal compartment forming the retaining chamber for housing the power source, shown as batteries, so that the power source/batteries are retained within the handle;

FIG. 4b is a cross-sectional view of the heated handle portion of FIG. 4a taken along line M-M;

FIG. 5 illustrates another embodiment of the heated handle construction wherein a cloth or fibrous handle is provided that slides onto a handle element of a device to provide heat to a user's hands;

FIG. 6 illustrates a side view of a walker with the heated handle construction integrated therein;

FIG. 7 illustrates a front view of a snow shovel with the heated handle construction integrated therein;

FIG. 8 illustrates a view of a stroller with the heated handle construction integrated therein;

FIG. 9 illustrates a side view of a wheelchair with the heated handle construction integrated therein along with heated arm rests;

FIG. 10 illustrates a view of a pair of crutches with the heated handle construction integrated therein along with heated arm rests;

FIG. 11a illustrates a view of a golf club with the heated handle construction integrated therein;

FIG. 11b illustrates a view of a hockey stick with the heated handle construction integrated therein;

FIG. 12 illustrates a view of a pet leash with the heated handle construction integrated therein; and

FIG. 13 illustrates a view of a knitting needle and/or crochet hook with the heated handle construction integrated therein.

### DESCRIPTION OF THE PREFERRED EMBODIMENTS

This invention relates to a heated handle construction for mounting or integration into umbrellas, canes, walkers, walking sticks, crutches, wheelchairs, snow shovels, baby carriages, strollers, golf clubs, hockey sticks, animal leads, pet leashes, knitting needles and crochet hooks, chain saws, construction tools, and handlebars for bicycle, scooters, snow mobiles and snow blowers, luggage, totes, brief cases, purses and hand bags. Briefly stated, the heated handle construction warms a user's hands while walking or working in frigid or cool temperatures. In the absence of the present invention, the handle temperature of such devices tends to reach the ambient temperature. Consequently, the handle becomes uncomfortable to grasp, especially in cold environments. In accordance with the present invention, the handle having a heated construction is provided with a heating element that raises the temperature of the handle surface to substantially the temperature of the hand, allowing the user to grip the handle with minimal discomfort. A warming effect on the user's hands is thereby produced, aiding comfort and relieving pain for individuals with arthritic hands. The handle may be integrated within the device, or may be detachable from the device, and may be presented as a system for interchanging on more than one mating devices.

Typically, the handle is made having an outer show layer and an inner insulating body such as a ceramic, wood or polymeric molded material. Due to the insulating character of the heated handle construction, its heating rate and cooling rate are very small. That is to say, the heated handle construction takes a long time to heat or cool. In a preferred embodiment, the heated handle construction is first wrapped with an insulating polymeric foam material, which is highly flexible and provides a soft cushiony feel to the handle. The plastic material in itself is highly insulating and the presence of closed cells of entrapped air provides additional insulation. This flexible foam is wrapped with a heating tape. The heating tape comprises a plurality of 25 micrometer diameter wires wound or laid in a zig zag pattern, and entrapped in a polymeric adhesive sheet. Such heating tapes are available from MINCO, and are described in detail at http://www.minco.com/uploadedFiles/Products/Thermofoil_Heaters/aa30-transparent_htrs. pdf. Alternatively, the heating tape may be a thin sheet of Grafoil, which has a resistivity, typically in the range of 1 to 8×10-4 ohm-inches that is approximately 5 to 25 times as that of a metal. Such Grafoil heating tapes are marketed by Q-foil, and are described in detail at http://www.egc-ent.com/html/qfoil.html. These thin flexible graphite foils are embedded in a plastic layer that may be adhesively coated. This thin polymeric coating on thermofoil heaters or Q-foil heaters protects the internal components of the handle while, at the same time, facilitating delivery of generated heat to the hand of the user. Owing to the insulating character of the handle and the use of insulating flexible polymeric foam, the heat generated is not lost or dissipated within the mass of the handle. The insulating foam cushions the handle, providing a comfortable grip without subjecting the wrapped heating elements to a sharp curvature. A sharp curvature typically has a small curvature radius and can potentially fracture a 25 micrometer heating wire or crack thin sheets of graphite foil. In the case of thermofoil heaters, which use 25 micrometer wires, a reflective metallic sheet or membrane may be inserted between the thermofoil element and the flexible polymeric foam to direct the infrared radiation from the heater to the hand of the user. The membrane may be a sheet of metal or a metallized polymeric sheet.

Most preferably, the integral heating element is a resistance wire or resistance ribbon. This resistance wire or ribbon is most preferably a nickel-chromium resistance wire, a non-magnetic alloy of nickel and chromium, such as that sold under the brand name Nichrome wire, as described and sold at http://www.pelicanwire.com/. The bare resistance wire and insulated resistance wire is available in stranded and is sold in a variety of sizes. The nickel-chromium resistance wire may be wound into coils. In particularly, the resistance wires would be the method of choice to heat the very ‘curvaceous’ devices, such as the j-shaped handles or the like, being that they are very easily able to be bent or wrapped around the core of the device in the manufacturing process. For example, if need be, these resistance wires can be wrapped around a figure “8” much easier than flexible heaters can. However, for some instruments, the heater used should be a ‘best fit’ choice. For example, wire types which may be utilized include thermocouple wire, solid & stranded resistance wire, high temperature heating wire, applicant wire (UL), glass core heater wire spirally wound, and ribbon wire as shown and described at http://www.pelicanwire.com/products.htm.

The heating element is connected through a user operated switch to a power source, preferably being a set of batteries connected in series, but wind power, fuel cells, or solar power may be utilized. The batteries or power source is contained in a retaining chamber, which in turn may be integrated within the stem of the heated handle of the device—cane, walker, stroller and/or snow shovel, or may alternatively be integrated within the handle portion itself. Preferably, the batteries are rechargeable and deliver a combined voltage of at least 12 volts, and on occasion as great as 25 volts or more, to produce and sustain enough heat for the heating to be effective. Preferably, the voltage delivered is greater than 12 volts. If the voltage is too low, it will affect the ability to maintain the desired heat level, and may result in a product which is too consumer demanding. With this voltage, the batteries can be easily charged using a charger connected to a house voltage outlet or directly charged by the cigarette lighter of a car or a van. Nickel metal hydride batteries or lithium batteries may be used. However, preferably, the batteries used are lithium ion batteries.

In a preferred embodiment, the user operated switch may have two positions. One of the switch positions can be used to drain the rechargeable battery that supplies power to the heating elements, or to use the cigarette lighter connection. In an alternate embodiment, the switch may include multiple positions delivering 50% or 100% of the heating current to the heating elements. Alternatively, the on-off switch is in communication with a thermostat to regulate flow of energy/power to the heating element and maintain the handle near a desired setpoint temperature. Utilizing the thermostat in the device allows the handle to automatically power-up or down the heat; thus, resulting in a more efficient conservation of power. Moreover, a motion sensor may be integrated into the heated handle construction that is in communication with the on-off switch to regulate flow of energy/power to the heating element, which further facilitates in conserving the battery power.

The outer layer of the handle portion is provided as the show surface and contact surface for the user's hand. The outer layer is preferably water proof, coated by a wax, silicone or Teflon (polytetrafluroethylene) material, to resist accumulation and penetration of water on the handle portion and visa vie the heating elements. The outer layer of the handle portion may be composed of the following materials: a polymeric material; a natural material, selected from a group consisting of wood, leather, shearling, suede, fur, or reptile skins; a fabric material, selected from a group consisting of wool, cashmere, blended knits, lycra, nylon, cotton or denim; a foam or rubber product; a plastic; a metal; a ceramic material; or a tourmaline material. Each device to be manufactured with these heated components will generally require application of engineering equations (i.e. Ohms law) to determine the appropriate ohms, resistance, voltage, and surface area to be heated based on the configuration and the material utilized in the handle construction. This will affect the amount of thermal heat-loss based on the type of external material that will be used to cover the heated handles. For example, it has been found that there is approximately a 2 degree Celsius heat loss when the handles are wrapped with a leather covering, this converts to approximately 4 degrees F. However, this heat-loss needs to be calculated for each external handle fabric to be used in production, and this will change resistances, voltages, ohms, etc. based on the particular configuration of the handle and material utilized.

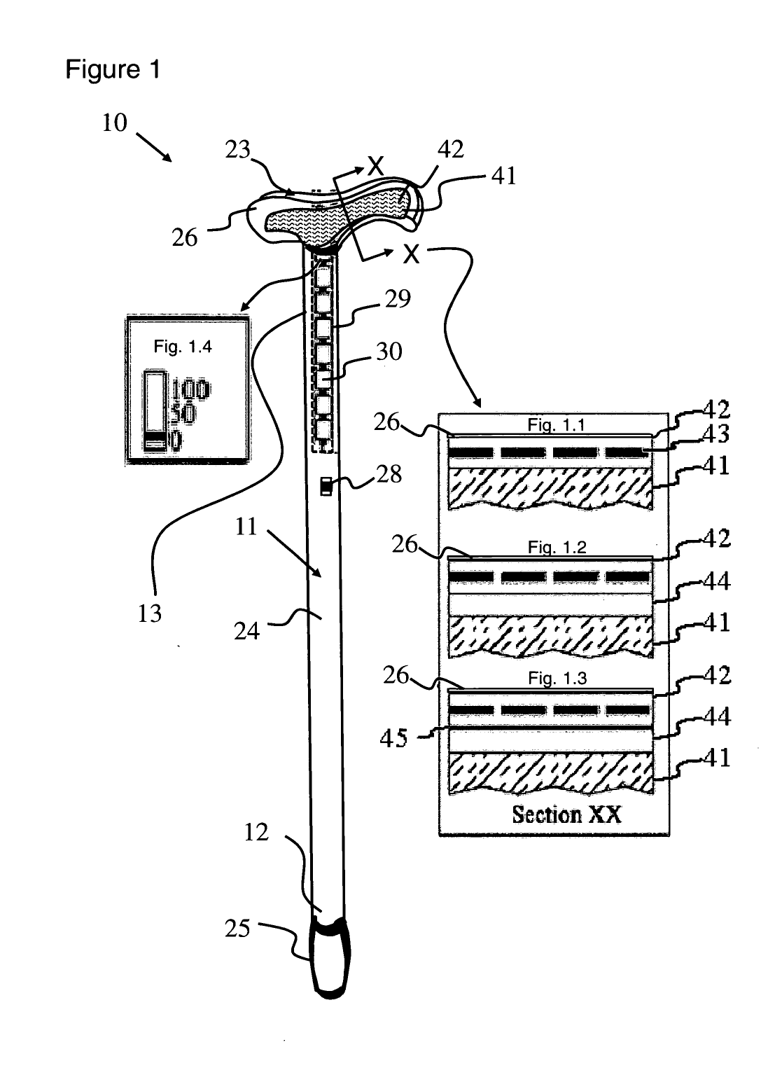

FIG. 1 illustrates generally at 10 a cross-sectional side view of a first device, shown as a walking stick or cane with the heated handle construction mounted thereon. The first device is shown as a walking stick 10 and includes an integral stem portion 11 having a distal end 12, central shaft 24 and a proximal end 13. On the distal end 12 there is a terminating member or bearing member 25, herein shown as a support pad or cushion as is typically utilized at the end of canes, walking sticks, walkers and the like. Stem portion 11 further includes a handle portion 23 located on or mounted on proximal end 13. Handle portion 23 may be permanently attached, but preferable handle portion 23 is detachable from proximal end 13. Handle portion 23 is constructed having an outer layer 26 and includes a thermally insulating material core 41 with integral heating elements 42 wrapped there around to adjust handle portion 23 to a warm temperature level. A retaining chamber for housing a power source therein is provided, herein the retaining chamber is shown at 29 and the power source is shown as a plurality of batteries 30 connected in series and powering heating elements 42 through an on-off switch 28.

Herein, on/ off switch 28 is shown located on the stem portion 11 of cane 10 and the power means/source comprises the plurality of batteries 30 housed within retaining chamber 29 incorporated in the central shaft 24. The batteries/power means 30 are connected in series and power heating element 42 through the on-off switch 28 located on the cane, walker, walking stick 10, snow shovel, or baby carriage. As switch 28 is turned to the on position, handle 23 is warmed efficiently to raise handle 23 to a warm temperature level. As a result the cane/walking stick 10, stroller, or shovel provides a heated handle 23 that is warm to the touch even during use at low temperatures outside when walking in wintry weather. Outer layer 26 is composed of a thin layer (ranging from 0.1 inch-1 inch in thickness) of material. This material may be a polymeric material or blend thereof, a foam or rubber product. Alternatively, the outer layer 26 of handle portion 23 may be composed of a natural material, selected from a group consisting of wood, leather, shearling, suede, fur, or reptile skins for comfort and aesthetic purposes. Optionally, the outer layer 26 of handle portion 23 may be composed of a fabric material, selected from a group consisting of wool, cashmere, blended knits, lycra, nylon, cotton or denim. The outer layer 26 may be a ceramic material or tourmaline material.

FIGS. 1.1-1.4 illustrate the details of the heated handle construction as utilized in walking stick 10 (as well as the stroller, walker, shovel, and other devices discussed hereinafter). Particularly: FIG. 1.1 illustrates the details of an insulating ceramic, wood or polymeric material of a handle wrapped with heating elements; FIG. 1.2 illustrates placement of an insulating foam material between the insulating handle and the wrapped heating elements; FIG. 1.3 illustrates placement of an infrared reflective foil or membrane between the heating element and the insulating foam material; and FIG. 1.4 illustrates an on-off switch with selectable heat delivery control. The heated handle is constructed from a thermally insulating material wrapped with integral heating elements, preferably resistance wire, to adjust the handle to a desired temperature level. Handle 23 (as well as the handles in the other figures herein) has a central core preferably made from an insulating ceramic, wood or polymeric material 41 and outer layer 26. In the first embodiment of the invention shown in FIG. 1.1, the heating element 42 is wrapped on the ceramic or polymeric insulating core 41 and outer layer 26 covers heating element 42 and the core 41. The heating element may comprise a set of metallic fine wires or Grafoil heaters 43 present in the encapsulated polymer of the heater or may comprise resistance wire wound around core 41. The second embodiment of the invention is shown in FIG. 1.2 wherein a flexible foam of polymeric material 44 which has air cells providing insulation is inserted between the ceramic or polymeric core 41 and the wrapped heating element 42. In the third embodiment of the invention, an infrared reflective metallic element 45 is inserted between the heating element 42 and the flexible foam of polymeric material 44. This infrared reflective metallic element 45 reflects the heat emitted by the heating element 42 towards the hand of the user and reduces its leakage into the ceramic or polymeric core 41. Outer layer 26 is generally thin in nature, having a thickness ranging from 0.1 inch to 1 inch thick so as to mitigate interference with heat transfer to the user's hand. However, each device to be manufactured with these heated components will require application determine of the appropriate ohms, resistance, voltage, and surface area to be heated based on the configuration and the material utilized in the handle construction, as the material utilized will affect the amount of thermal heat-loss. For example, it has been found that there is approximately a 2 degree Celsius heat loss when the handles are wrapped with a leather covering, this converts to approximately 4 degrees F. However, this heat-loss needs to be calculated for each external handle fabric to be used in production, and this will change resistances, voltages, ohms, etc. based on the particular configuration of the handle and material utilized and will also determine the amount of power required.

While the placement of the infrared reflective element shown in FIG. 1.3 is between the heating element and the flexible insulating foam material, it should be understood that the infrared reflective element may alternatively be placed between the heating element and the insulating handle without the use of flexible insulating foam. The stem portion of the cane, shovel, or stroller houses the power source which is shown to be series connected eight 1.5 volt cell adapted to produce a voltage of 12 volts. The voltage should be at least 12 volts, and preferably is greater than 12 volts, reaching as high as 25 volts or more, to more efficiently warm the handle and maintain such warmth. The series connected batteries power the heating elements through an on/off switch 28, the details of which are shown in FIG. 1.4. The switch, in addition to on and off positions, has a low heat intensity level at 50% value, as shown. A socket is provided for connecting to the cigarette lighter connection in a car or SUV, enabling charging of rechargeable batteries 30 or the use of cigarette lighter power to drive the heating elements 42. On-off switch 28 may be in communication with a thermostat to regulate flow of energy/power to heating elements 42 and maintain the handle near a desired setpoint temperature to more efficient conservation of power. Moreover, a motion sensor may be integrated into the heated handle construction that is in communication with on-off switch 28 to regulate flow of energy/power to heating elements 42, which further facilitates in conserving battery power.

A variety of shaped or sized heated handle constructions can be utilized, such as “J” curved handles such as in the shape of the traditional cane, a straight handle, a finger-grooved handle, a semi U-shaped bar such as in the shape of a baby stroller handles, and the like. Use of resistance wire as the heating element has been shown to be optimal due to its flexibility, allowing it to be very easily bent or wrapped around the core 41 of the device. Optionally, the outer layer of the heated handle construction may be substantially water proof and thereby resist accumulation and penetration of water on the handle portion and the heating element. In particular, the outer layer may be coated with a material selected from a group consisting of wax, silicone or Teflon (polytetrafluroethylene). A heightened handle temperature radiates heat into the hands of the user, providing relief to those suffering from arthritis and carpal tunnel syndrome.

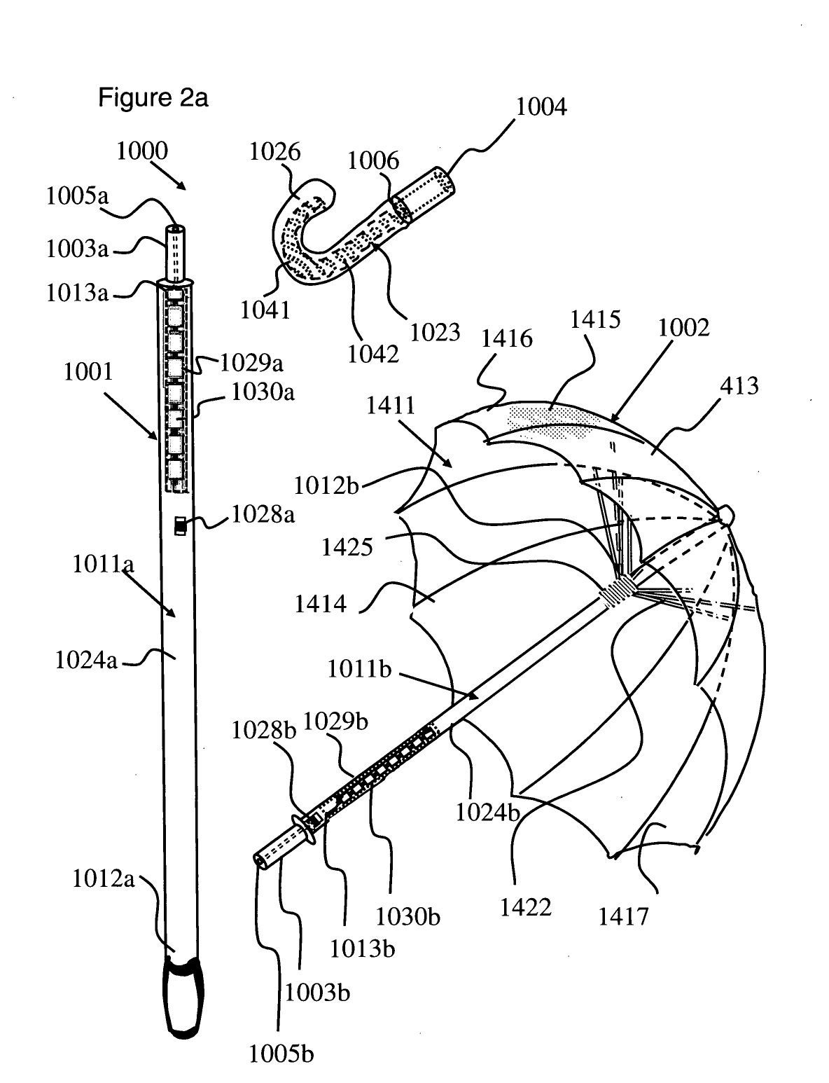

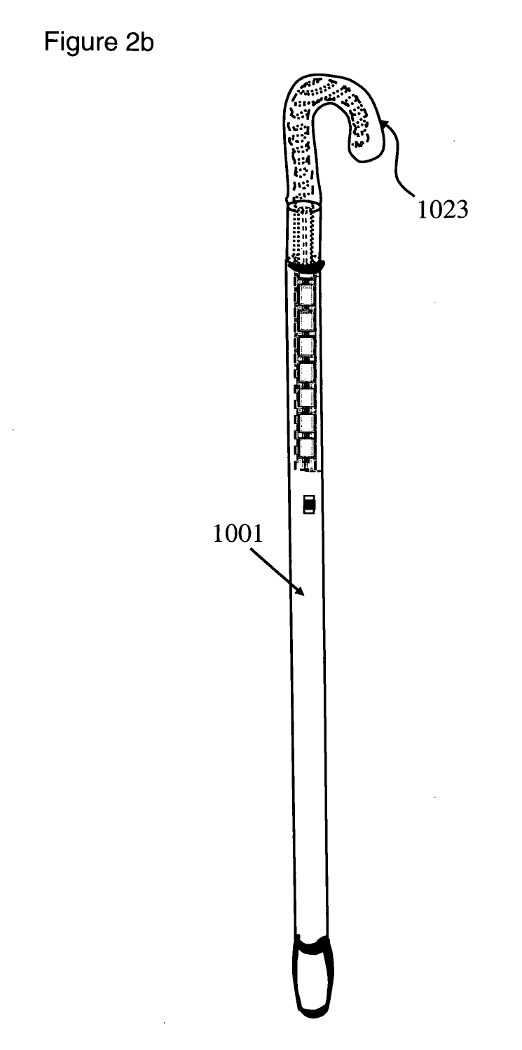

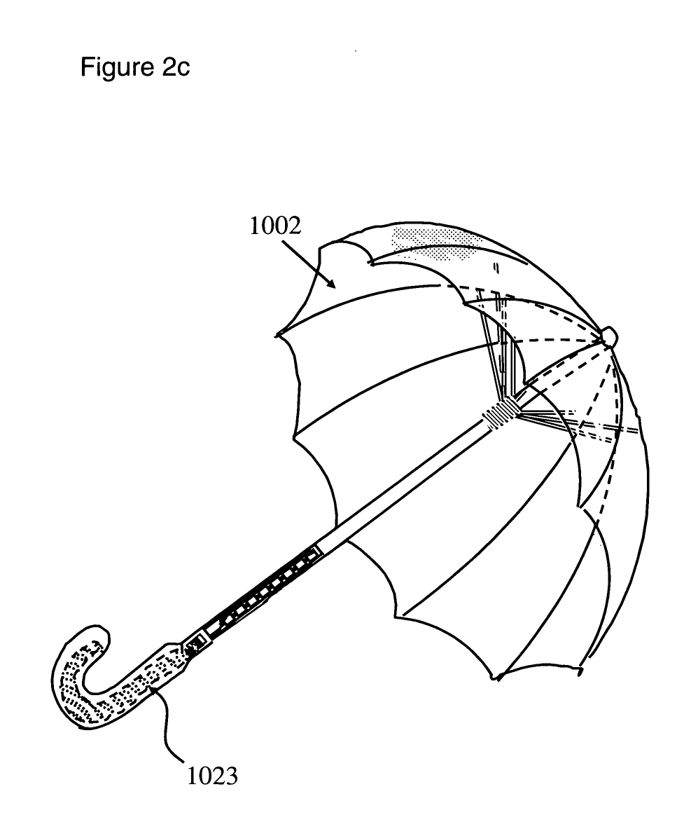

FIG. 2a illustrates an embodiment of the heated handle construction wherein the handle is interchangeable between multiple devices, shown generally at 1000. Herein, handle portion 1023 is detached from a first device, shown as a cane/walking stick 1001, and is provided to be attached to a second device, shown as an umbrella 1002, so that the heated handle construction 1000 is interchangeably received on these devices. Handle portion 1023 is constructed having an outer layer 1026 and includes a thermally insulating material core 1041 with integral heating elements 1042 wrapped there around to adjust handle portion 1023 to a warm temperature level. Each device, cane 1001 and umbrella 1002, include an integral stem portion 1011a, 1101b having a distal end 1012a, 1012b, central shaft 1024a, 1024b and a proximal end 1013a, 1013b. Handle portion 1023 is appointed to be mounted on the proximal end 1013a, 1013b of each stem portion 1011a, 1011b of cane 1001 and umbrella 1002, respectively. Stem portion 1011a, 1011b further includes a handle attachment means 1003a, 1003b appointed to act as mounting means for mounting handle portion 1023 to each device 1001, 1002, respectively. Handle portion 1023 includes mating mounting means, herein shown as a handle aperture 1004, appointed to attach onto handle attachment means 1003a, 1003b of proximal end 1013a, 1013b of stem portion 1011a, 1011b in a mating configuration. The mounting means for engagement between handle aperture 1004 and handle attachment means 1003a, 1003b of the devices 1001, 1002 is preferably a snap, screw, pivot or mating groove engagement provided to secure handle portion 1023 to proximal end 1013a, 1013b of stem portion 1011a, 1011b to lock handle portion 1023 into place during use.

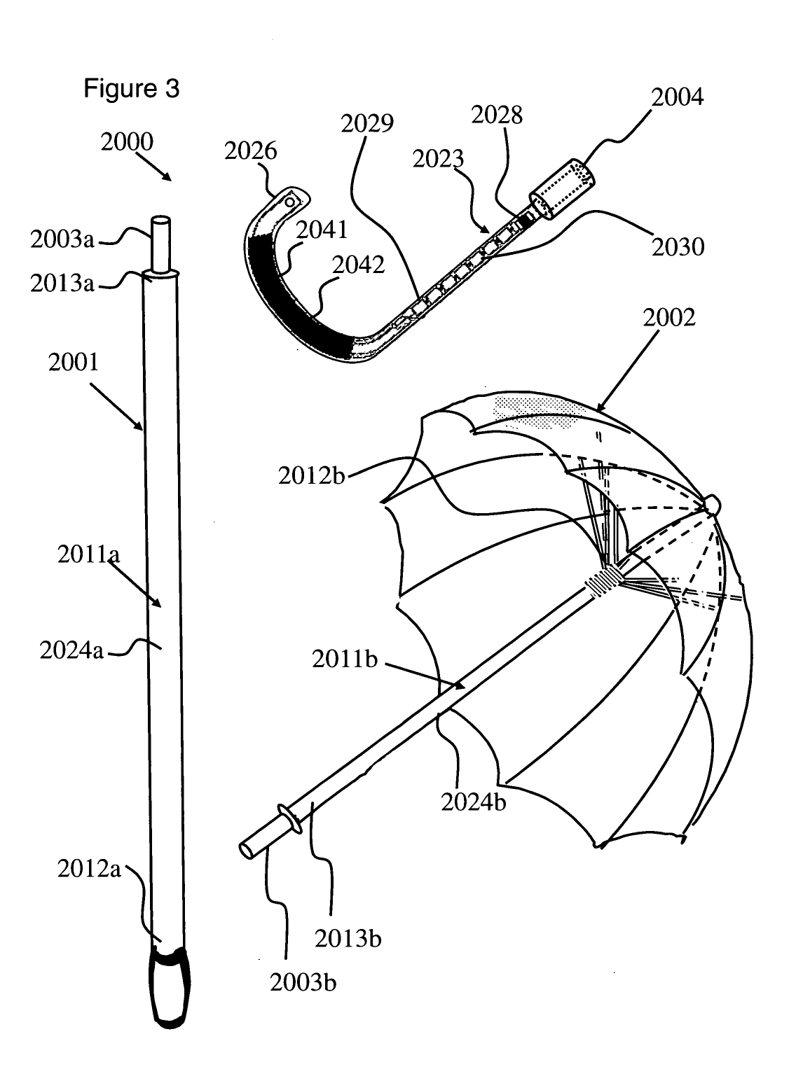

A retaining chamber 1029a, 1029b is shown herein integrated within each of devices 1001, 1002, however, retaining chamber 1029a, 1029b may instead be integrated within the handle portion 1023 (as shown in FIG. 3). Retaining chamber 1029a, 1029b is provided for housing a power source, herein shown as a plurality of batteries 1030a, 1030b connected in series and powering heating elements 1042 through an on-off switch 1028a, 1028b shown on integral stems 1011a, 1011b (the on-off switch 1028a, 1028b, may instead be integrated within handle portion 1023, as shown in FIG. 3). In this manner, central shaft 1024a, 1024b of stem portion 1011a, 1011b has a hollow cavity forming retaining chamber 1029a, 1029b for housing batteries 1030a, 1030b connected in series and delivering power through a terminal lead 1005a, 1005b integrated in association with handle attachment means 1003a, 1003b of proximal end 1013a, 1013b of stem portion 1011a, 1011b. In turn, handle portion 1023 further includes an adapter 1006 appointed to connect with terminal lead 1005a, 1005b to supply power to heating elements 1042 communicated by on-off switch 1028a, 1028b.

Continuing with FIG. 2a, preferably umbrella 1002 includes a canopy portion 1411, a spring member 1425, and extension rods 1422. Canopy 1411 has branches 1414 extending therethrough. Branches 1414 are attached to extension rods 1422 so that the branches 1414 expand when the extension rods 1422 are extended to form an open state of the umbrella. Conversely, when extension rods 1422 are contracted or folded, branches 1414 retract to form a closed state of the umbrella, such as when it is being stored away after or between uses. Canopy 1411 is constructed of a fabric having an exterior surface 1416 and an interior surface 1417. Exterior surface 1416 of canopy 1411 is water repellant, having a wax, Teflon or silicone coating, a portion of which is shown herein at 1415. Using umbrella 1002 with heated handle portion 1023 in conjunction with the water repellant canopy 1411 allows the user to transition from a rainy environment to a dry environment without accumulation of water droplets on the umbrella handle. The repellency feature of the canopy 1411 prevents saturation thereof with water droplets, and drives water in a direction away from handle portion 1023. A heightened handle temperature radiates heat into the hands of the user, providing relief to those suffering from arthritis and carpal tunnel syndrome.

FIG. 2b illustrates the heated handle construction of FIG. 2a wherein the handle portion 1023 is mounted onto cane/walking stick 1001; FIG. 2c illustrates the heated handle construction of FIG. 2a wherein the handle portion 1023 is mounted onto umbrella 1002. The removability of the heated handle portion not only allows safe-keeping of the handle during non-use, but conveniently allows a user to interchange the handle portion from one device to another simply by snapping, screwing, pivoting, or locking the handle portion into place on the device. In this manner, the handle portion 1023 may be sold as a system or kit, such as sold with two or more devices—i.e. a cane and an umbrella; a set of golf clubs so that one can switch over the heated handle based on the club selected; a set of fishing rods; ice scraper and ice brush devices; ski poles and hockey stick sets; or the like. Thus, handle portion 1023 would be interchangeable with each device sold in the system, or sold separate from the system but provided with a mating configuration for mounting of the handle portion thereon.

FIG. 3 illustrates an embodiment of the heated handle construction wherein the handle is interchangeable between multiple devices, and wherein the handle comprises an internal compartment forming the retaining chamber for housing the power source, shown as batteries, so that the power source/batteries are retained within the handle, shown generally at 2000. Herein, handle portion 2023 is detached from a first device, shown as a cane/walking stick 2001, and is provided to be attached to a second device, shown as an umbrella 2002, so that the heated handle construction 2000 is interchangeably received on these devices. Handle portion 2023 is constructed having an outer layer 2026 and includes a thermally insulating material core 2041 with integral heating elements 2042 wrapped there around to adjust handle portion 2023 to a warm temperature level. Each device, cane 2001 and umbrella 2002, include an integral stem portion 2011a, 2011b having a distal end 2012a, 2012b, central shaft 2024a, 2024b and a proximal end 2013a, 2013b. Handle portion 2023 is appointed to be mounted on the proximal end 2013a, 2013b of each stem portion 2011a, 2011b of cane 2001 and umbrella 2002, respectively. Stem portion 2011a, 2011b further includes a handle attachment means 2003a, 2003b appointed to act as mounting means for mounting handle portion 2023 to each device 2001, 2002, respectively. Handle portion 2023 includes mating mounting means, herein shown as a handle aperture 2004, appointed to attach onto handle attachment means 2003a, 2003b in a mating configuration. Mounting means may be provided via mating snaps, screws, tongue and groove, or pivot to lock the handle portion into place on the device.

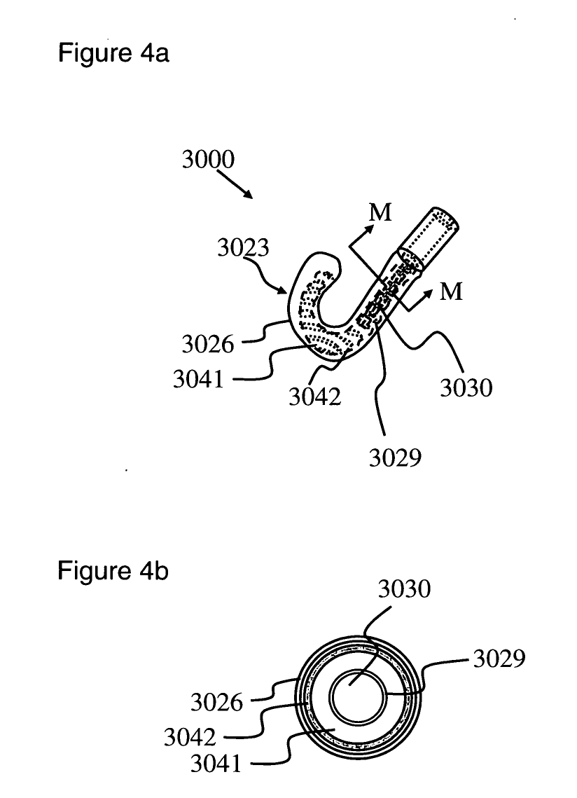

Handle portion 2023 further includes an internal compartment forming retaining chamber 2029 for housing a power source, herein shown as a plurality of batteries 2030 connected in series and powering heating elements 2042 through an on-off switch 2028, also on handle portion 2023. Herein, internal compartment forming retaining chamber 2029 of handle portion 2023 is located in an abutting configuration to heating elements 2042, as shown. Alternatively, as shown in FIGS. 4a and 4b, the internal compartment forming the retaining chamber is located in an overlapping configuration, under thermally insulating material core and heating elements.

In FIGS. 4a and 4b, another embodiment wherein the handle portion houses the power source and on-off switch is shown, generally at 3000, appointed to be utilized similarly to the embodiment of FIG. 3. FIG. 4b shows a cross-sectional view of handle configuration 3000 taken along M in FIG. 4a. In this embodiment the heated handle 3023 is constructed having an outer layer 3026 and includes a thermally insulating material core 3041 with integral heating elements 3042 wrapped there around to adjust handle portion 3023 to a warm temperature level. Further, an internal compartment forming the retaining chamber 3029 is provided under thermally insulating material core 3041 for housing the power source, shown as batteries 3030. This allows for a more lengthwise compact handle configuration than that shown in FIG. 3.

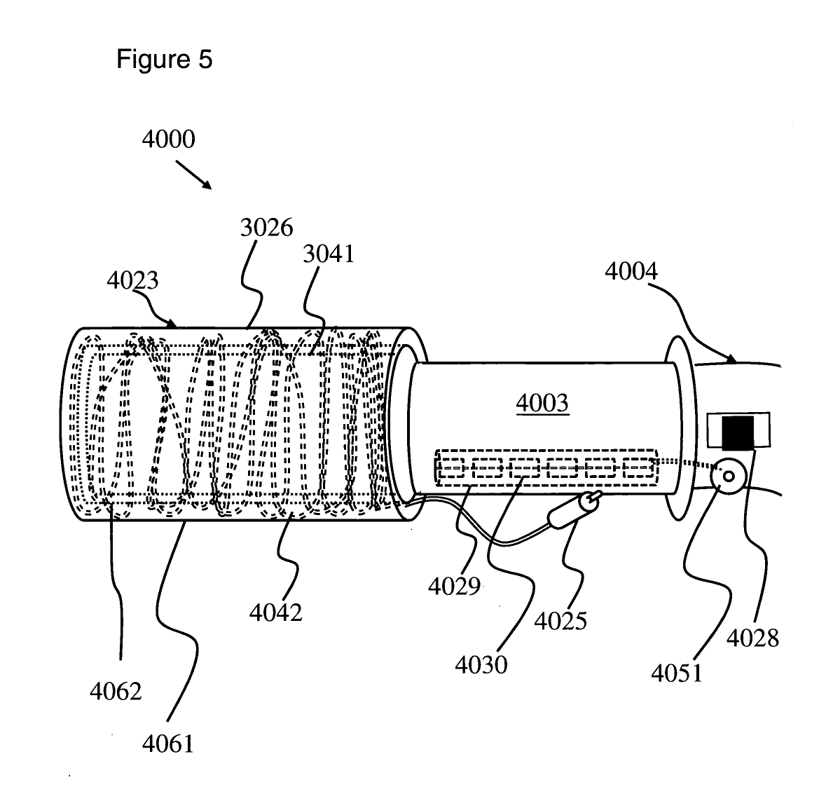

FIG. 5 illustrates another embodiment of the heated handle construction wherein a cloth or fibrous handle is provided that slides onto a handle element of a device to provide heat to a user's hands, shown generally at 4000. In this embodiment, a heated handle construction 4023 is provided for mounting on a handle element 4003 of at least one device 4004. Handle 4023 comprises a thermally insulating material 4041, an outer layer 4026, and integral heating elements 4042 for temperature adjustment, and a handle adapter 4025 for delivering power to heating elements 4042. Device 4004, which may be a plethora of devices, such as a handlebar for a bicycle, scooter, motor cycle, or a handle for an umbrella, cane, etc., herein includes handle element 4003 having a retaining chamber 4029 for housing a power source, shown as batteries 4030, in communication with an on-off switch 4028 and in connection with a lead 4051 for delivering power to handle adapter 4025 of handle 4023. In this embodiment, outer layer 4026 of handle 4023 is composed of a cloth or fibrous material and comprises a primary layer 4061 and a secondary layer 4062 forming a dual layered cloth-like covering. Heating element 4042 is housed between this secondary layer 4062 and primary layer 4061. Secondary layer 4062 includes thermally insulating material 4041; further, handle element 4003 of device 4004 preferably further is generally composed of the thermally insulating material—or includes an outermost coating of thermally insulating material to further enhance insulation of heat transfer during operation of handle 4023. In operation, the cloth-like covering slides over the integrated handle element 4003 of the device 4004 and the handle adapter is plugged into the lead of the device and power is controlled by the on-off switch 4028.

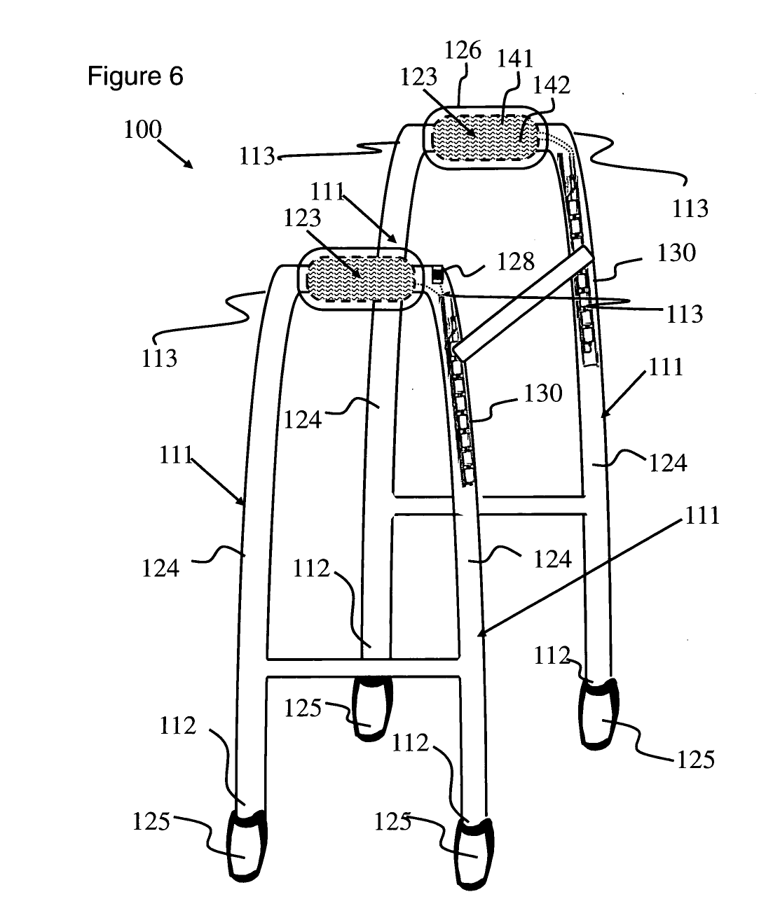

FIG. 6 illustrates a side view of a walker with the heated handle construction integrated therein or detachably mounted thereon, as shown in FIGS. 1-5. An integral stem portion is constructed as an inverted U-shape having parallel legs to form a walker device, shown generally at 100. The heated handle construction is shown in FIGS. 1.1-1.4 discussed hereinabove. Walker 100 includes an integral stem portion 111 having a distal end 112 and a proximal end 113. Stem portion 111 further includes a handle 123 located on proximal end 113, a central shaft 124, and a bearing member 125 located on distal end 112. Bearing member 125 is a support pad or cushion as is typically utilized at the end of canes, walking sticks, walkers, and the like. Handle portion 123 is constructed having an outer layer 126 and includes a thermally insulating material core 141 with integral heating elements 142 wrapped there around. An on/off switch is shown at 128 for actuating power means 130 comprising a plurality of batteries incorporated in the central shaft 124 connected in series and power a heating element through the on-off switch 128 located on the walker's legs. Dual power means 130 are provided, as shown; alternatively there may be a single power means 130 located in one of the legs or in proximity to the handles 123.

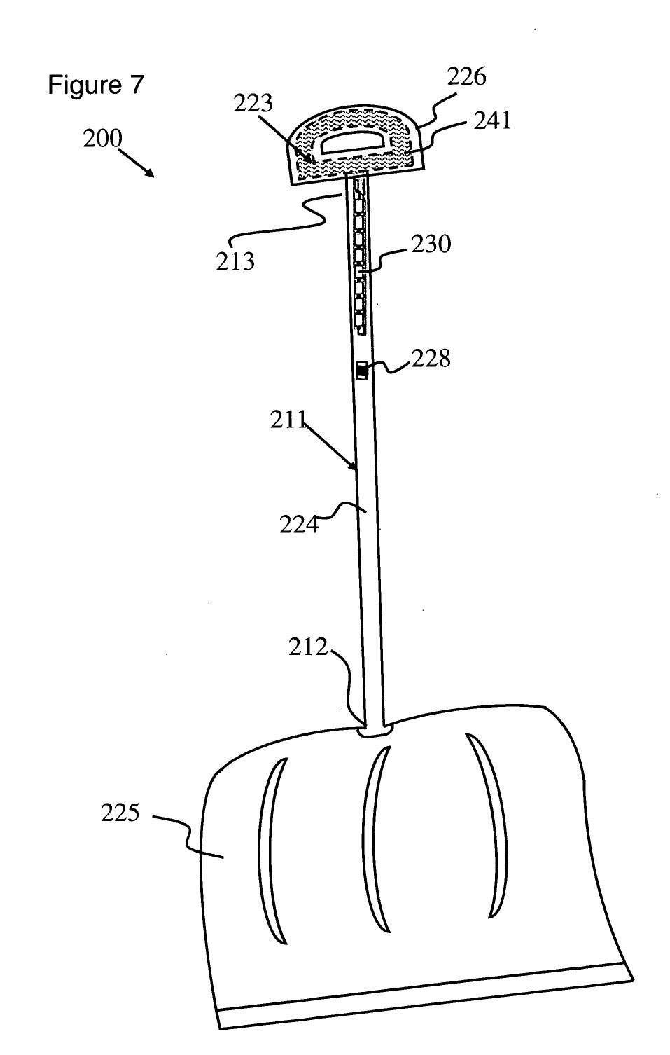

FIG. 7 illustrates a front view of a snow shovel with the heated handle construction integrated therein or detachably mounted thereon, as shown in FIGS. 1-5, shown generally at 200. The heated handle construction is shown in FIGS. 1.1-1.4 discussed hereinabove. Shovel 200 includes an integral stem portion 211 having a distal end 212 with a bearing member 125, herein shown as a shovel blade. A proximal end 213 is provided with a handle 223. A central shaft 224 includes an on/off switch is shown at 228 for actuating power means 230 comprising a plurality of batteries incorporated in the central shaft 224 connected in series and power a heating element through the on-off switch 228. Handle portion 223 is constructed having an outer layer 226 and includes a thermally insulating material core 241 with integral heating elements wrapped there around.

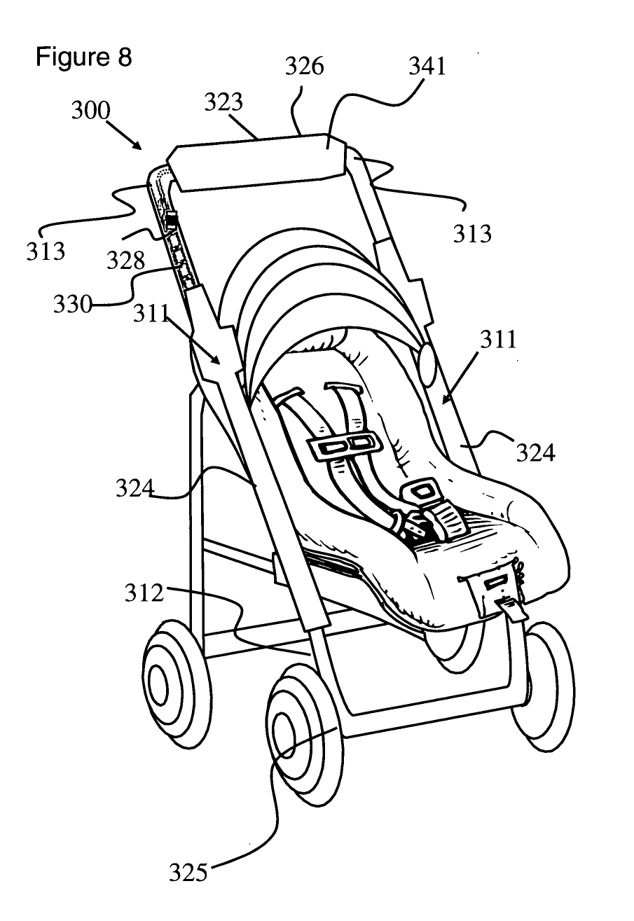

FIG. 8 illustrates a view of a stroller with the heated handle construction integrated therein or detachably mounted thereon, as shown in FIGS. 2-5, shown generally at 300. The heated handle construction is shown in FIGS. 1.1-1.4 discussed hereinabove. Baby Carriage 300 includes dual integral stem portions 311 having a distal end 312 with a bearing member 325, herein attached to wheels. Each of the proximal ends 313 converge to provide a handle 323 having an outer layer 326 and a thermally insulating material core 341 wrapped with integral heating elements. Alternatively, the proximal ends 314 may not converge, as with some strollers, and therefore each handle includes the ability to be heated via as described herein. A central shaft 324 includes an on/off switch 328, which is shown on one of the integral stem portions 311, for actuating power means 330. Power means 330 comprises a plurality of batteries incorporated in the central shaft 324 of one of the integral stem portions 311 (optionally, both stem portions may include the power means) connected in series and power a heating element through the on-off switch 328 and leading to each handle 323 on each of the integral stem portions 311.

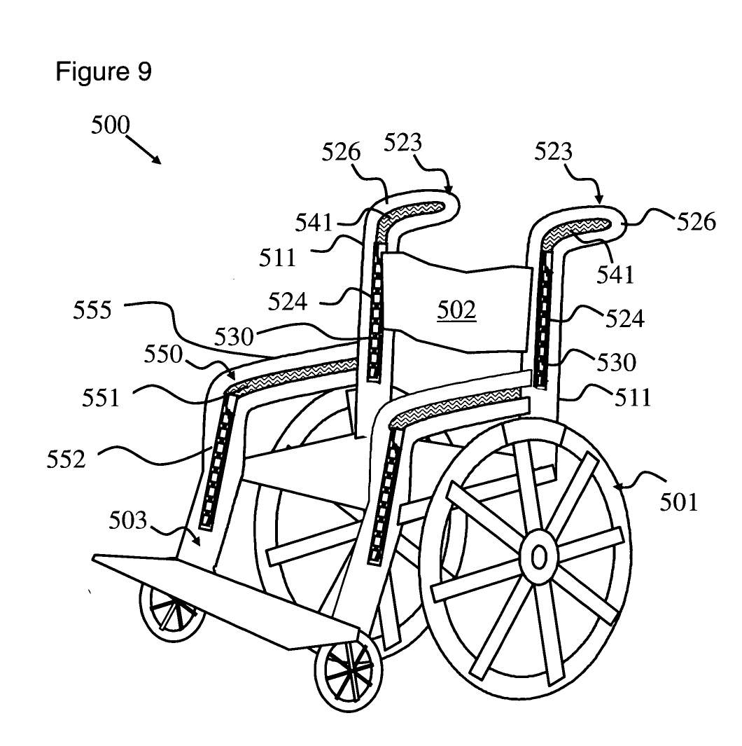

FIG. 9 illustrates a view of a wheelchair with the heated handle construction integrated therein or detachably mounted thereon, as shown in FIGS. 1-5, along with heated arm rests, shown generally at 500. The heated handle construction is shown in FIGS. 1.1-1.4 discussed hereinabove. Wheelchair 500 includes wheels 501, chair 502 and frame 503. Frame 503 includes dual integral stem portions 511. Each of the proximal ends of stem portions 511 converge to provide a handle 523 having an outer layer 526 and a thermally insulating material core 541 wrapped with integral heating elements. A central shaft 524 includes an on/off switch for actuating power means 530, comprising a plurality of batteries incorporated in the central shaft 524 of one of the integral stem portions 511. In this embodiment, wheelchair 500 further includes heated arm rests 550 comprising an inner thermally insulating material bar 551 wrapped with integral heating elements and an outer cushioned layer 555. Batteries/power means are located in housing trunk 552 and are connected in series to communicate with the heating elements wrapped around inner thermally insulating material bar 551 through an arm rest on-off switch to provide a comfortable temperature to the user's arms.

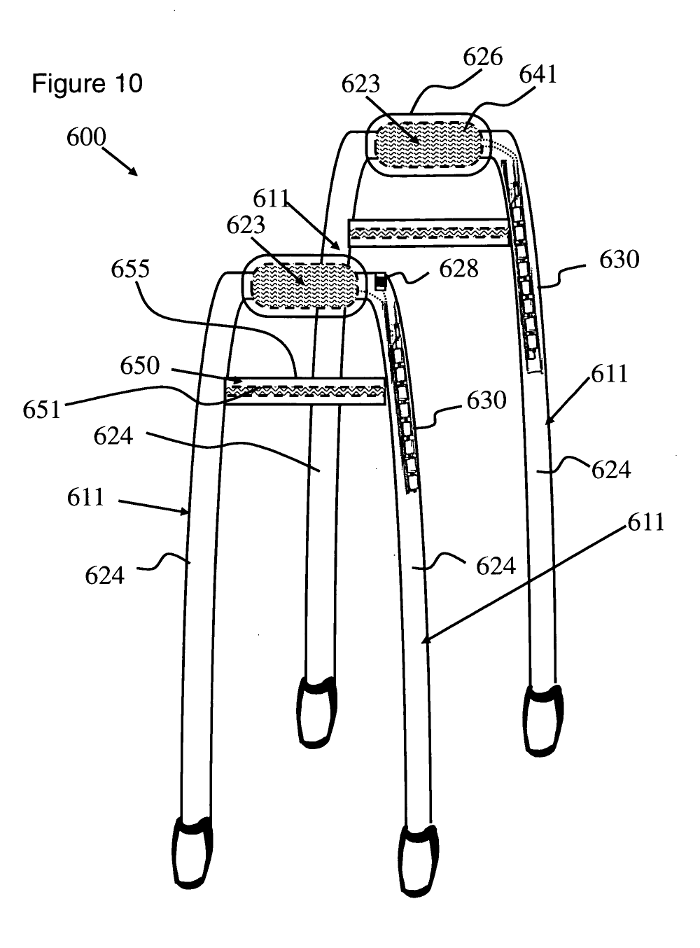

FIG. 10 illustrates a view of a pair of crutches with the heated handle construction integrated therein or detachably mounted thereon, as shown in FIGS. 1-5, along with heated arm rests, shown generally at 600. The heated handle construction is shown in FIGS. 1.1-1.4 discussed hereinabove. Crutches 600 include dual integral u-shaped stem portions 611 having a handle 623 with an outer layer 626 and a thermally insulating material core 641 wrapped with integral heating elements. A central shaft 624 includes an on/off switch 628 for actuating power means 630, comprising a plurality of batteries. In this embodiment, crutches 600 further include heated arm rests 650 comprising an inner thermally insulating material bar 651 wrapped with integral heating elements and an outer cushioned layer 655, herein also powered by power means 630, but can be provided with their own respective battery power means.

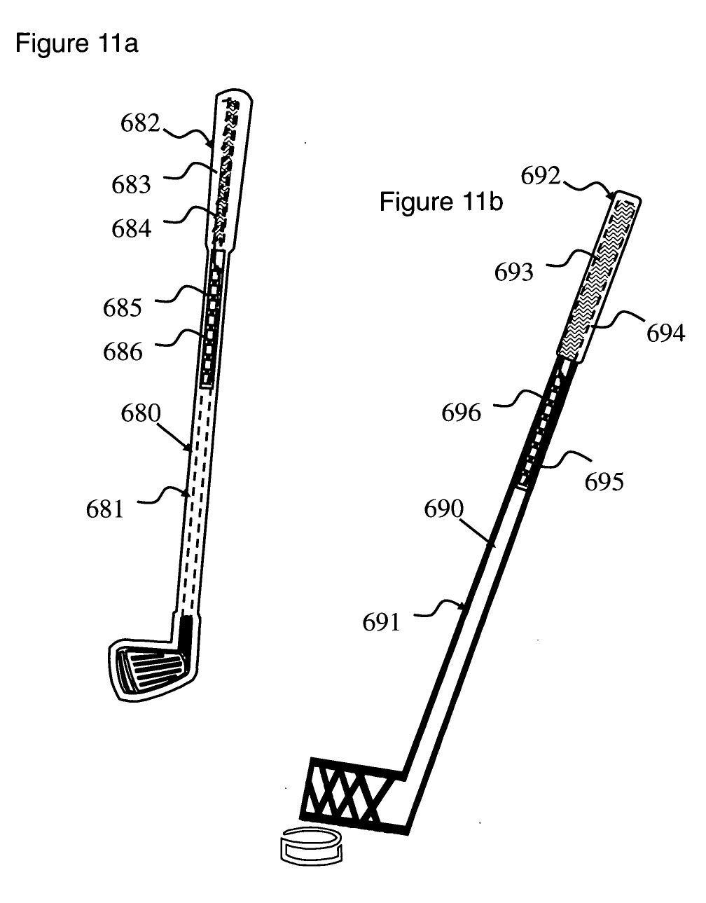

FIG. 11a illustrates a view of a golf club with the heated handle construction integrated therein or detachably mounted thereon, as shown in FIGS. 1-5. Club 680 includes integral stem 681 with heated handle portion 682 comprising an outer layer 683 and a thermally insulating material core 684 wrapped with integral heating elements activated via current supplied by power means 686, batteries, housed in central shaft 685 actuated by an on/off switch. FIG. 11b illustrates a view of a hockey stick 690 having an integral stem 691 with heated handle portion 692 comprising an outer layer 693 and a thermally insulating material core 694 wrapped with integral heating elements activated via current supplied by power means 696, batteries, housed in central shaft 695 actuated by an on/off switch. The handle 682 and 692 may be the same handle and be interchangeably mounted on each of the devices, golf club and hockey stick, for example.

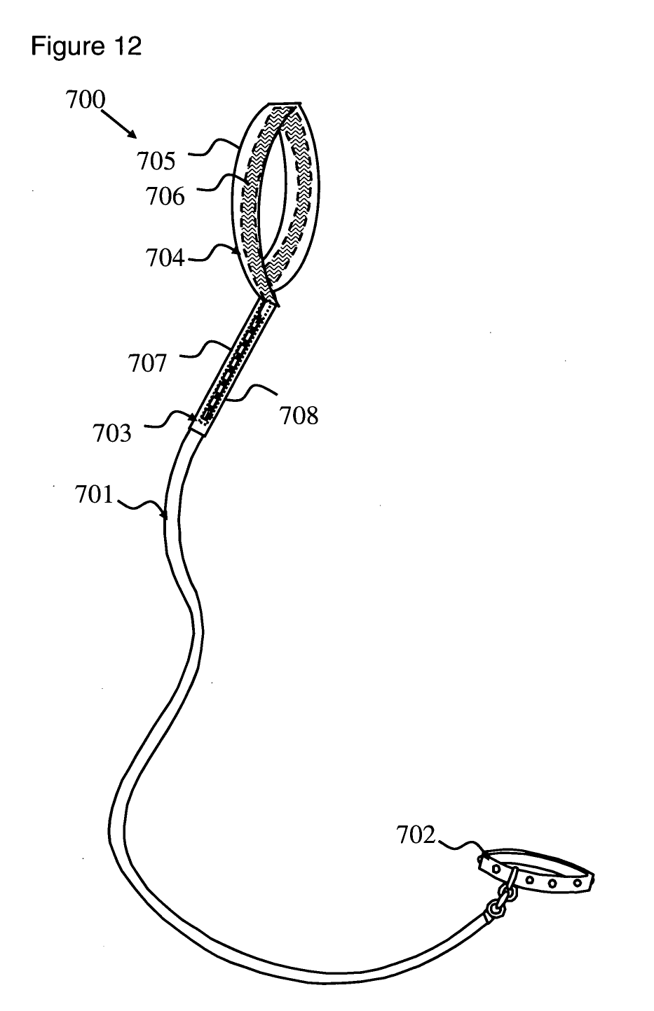

FIG. 12 illustrates a view of a pet leash with the heated handle construction integrated therein or detachably mounted thereon, as shown in FIGS. 1-5, shown generally at 700. Pet leash 700 includes a typical fibrous body portion 701 appointed to connect to a collar 702 for placement around an animal's neck. On the proximal end of body portion 701 of leash 700 there is a hardened integral stem 703, preferably comprised of a light weight durable plastic tube shaped portion. Integral stem 703 includes a heated handle portion 704, which is preferably constructed with a fibrous outer layer 705 and a flexible thermally insulating material core 706 wrapped with integral heating elements (discussed infra via FIGS. 1.1-1.4) activated via current supplied by power means 707, batteries, housed in a central shaft 708 located in integral stem 703 and actuated by an on/off switch. A harness may be provided, wherein the harness handle includes the heated handle configuration.

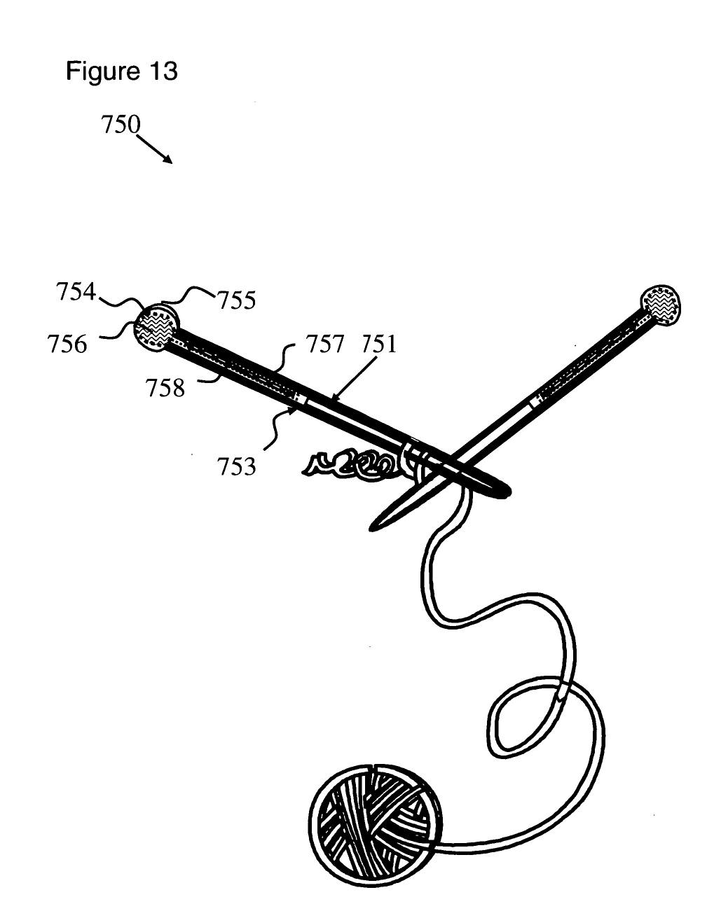

FIG. 13 illustrates a view of a knitting needle and/or crochet hook with the heated handle construction integrated therein or detachably mounted thereon, as shown in FIGS. 1-5 discussed hereinabove, shown generally at 750. Knitting needle 751 includes an integral stem 753 with a heated handle portion 754 having an outer layer 755 substantially surrounding a flexible thermally insulating material core 756 wrapped with integral heating elements activated via current supplied by power means 758, batteries, housed in a central shaft 757 located in integral stem 753 and actuated by an on/off switch.

The heated handle construction for integration/detachable mounting onto umbrellas, canes, walkers, walking sticks, crutches, wheelchairs, snow shovels, baby carriages, strollers, golf clubs, hockey sticks, animal leads, pet leashes, and knitting needles and crochet hooks of the present invention comprises, in combination, the following salient features:
i) an integral stem portion having a distal end and a proximal end;
ii) the integral stem portion comprising a handle located on the proximal end, a central shaft, and a bearing member located on the distal end;
iii) a retaining chamber built into either the stem portion or the handle portion that is appointed for retaining a power source, preferably being a plurality of batteries, most preferably rechargeable batteries, but alternatively or additionally comprising fuel cells, solar power and wind power components;
iv) the handle portion optionally being provided within a system including more than one device so that the handle portion can be mounted interchanging from one device to another to suit the needs of a user;
v) the handle portion being constructed from a thermally insulating material core and an external outer layer;
vi) the handle portion being wrapped with integral heating elements to adjust said handle to a temperature level;
vii) the batteries being connected in series or in parallel, and powering said heating element through an on-off switch;
viii) optionally, the handle's outer layer is substantially water proof and thereby resisting accumulation and penetration of water on the handle portion and the heating element;
ix) the core of the handle portion being constructed from an insulating polymeric, wood or ceramic material that is wrapped with integral heating elements;
x) the heating elements comprising flexible tape or flexible strip;
xi) the heating elements preferably comprising resistance wire or resistance ribbon;
xii) optionally a foam of flexible tape being disposed between the insulating polymeric, wood or ceramic material and said heating elements, limiting heat transmission to the insulating polymeric, wood or ceramic material;
xiii) optionally an infrared reflective metallic strip being placed under the heating element to direct infrared heat from heating elements to the hand of the user;
xiv) the batteries being connected in series or in parallel, and powering the heating element through an on-off switch that is optionally provided with a heating intensity control;
xv) optionally the batteries providing at least 12 volts, thereby matching common voltage available in a cigarette lighter terminal of a car or SUV, or either solely or in conjunction with a voltage extender for increasing voltage output to as high as 25 volts or more, is appointed for charging the rechargeable batteries;

While the integrated/detachable heated handle is disclosed with respect to a handle of umbrellas, canes, walkers, walking sticks, crutches, wheelchairs, snow shovels, baby carriages, strollers, golf clubs, hockey sticks, animal leads, pet leashes, and knitting needles and crochet hooks, the same heated handle configuration may be used for heating integral handles of other appliances, and tools, such as ice scrapers, snow blowers, ski poles, and the like.

Having thus described the invention in rather full detail, it will be understood that such detail need not be strictly adhered to, but that additional changes and modifications may suggest themselves to one skilled in the art. For example, the distal end of the cane or walker could have the shape of a palm grip, which may optionally be constructed for left-handed or right-handed use. Depending upon the size of the heated handle construction, there may be a need for two distal ends and/or two proximal ends which, if present, may require an additional heat source. A double baby stroller represents an example where, owing to the additional width of the handle, the stroller may profitably utilize a heated handle construction having two proximal ends and/or two distal ends. Such modifications are intended to fall within the scope of the invention as defined by the subjoined claims.

What is claimed is:

1. A heated handle construction, comprising:
a. an integral stem portion integrated within a first device having a distal end, central shaft and a proximal end, said proximal end being appointed to engage with a handle portion;
b. a retaining chamber for housing a power source therein;
c. said handle portion being constructed from a thermally insulating material and having an outer layer;
d. said handle portion being wrapped with integral heating elements to adjust said handle to a temperature level;
e. said power source being electrically connected to and powering said heating element through an on-off switch;
whereby said handle is warmed efficiently to raise said handle to a temperature level that provides a comfortable grip for the user.

2. A heated handle construction as recited by claim 1, wherein said handle is detachable from said proximal end of said integral stem portion of said first device.

3. A heated handle construction as recited by claim 1 comprising a plurality of devices, each having an integral stem portion appointed to interchangeably receive said handle.

4. A heated handle construction as recited by claim 3, wherein said plurality of devices includes a second device being an umbrella and said first device comprises a cane so that said handle can be interchangeably received on each of said first and second device.

5. A heated handle construction as recited by claim 2, wherein said handle comprises mounting means.

6. A heated handle construction as recited by claim 5, wherein said mounting means comprises a handle aperture appointed to attach onto said proximal end of said stem portion in a mating configuration.

7. A heated handle construction as recited by claim 6, wherein said mounting means is selected from a group consisting of snap, screw, pivot or mating grooves provided to secure said handle to said proximal end of said stem portion and lock said handle into place.

8. A heated handle construction as recited by claim 2, wherein said handle comprises an internal compartment forming said retaining chamber for housing said power source so that said power source is retained within said handle.

9. A heated handle construction as recited by claim 2, wherein said central shaft of said stem portion has a hollow cavity to form said retaining chamber for housing said power source therein, said power source delivering power through a terminal lead integrated in association with said proximal end of said stem portion, and wherein said handle comprises an adapter appointed to matingly connect to said terminal lead to supply power to said heating element communicated by said on-off switch.

10. A heated handle construction as recited by claim 1, wherein said central shaft of said stem portion has a hollow cavity to form said retaining chamber for housing said power source therein.

11. A heated handle construction as recited by claim 1, wherein said thermally insulating material is selected from a group consisting of molded polymer, wood or ceramic.

12. A heated handle construction as recited by claim 1, wherein said outer layer of said handle is composed of a cloth or fibrous material forming a cloth-like covering.

13. A heated handle construction as recited by claim 12, wherein said outer layer of said handle is composed of a cloth or fibrous material comprising a primary layer and a secondary layer forming a dual layered cloth-like covering that can be readily mounted onto a handle element of said first device.

14. A heated handle construction as recited by claim 13, wherein said heating element is housed between said secondary and primary layers of said outer layer of said handle, wherein said cloth-like covering covers said thermally insulating material of said handle and said batteries deliver power to said heating element communicated by said on-off switch.

15. A heated handle construction as recited by claim 1 comprising a thermostat in communication with said on-off switch to regulate flow of energy/power to said heating element and maintain said handle near a desired setpoint temperature.

16. A heated handle construction as recited by claim 1 comprising a motion sensor in communication with said on-off switch to actuate flow of energy/power to said heating element in response to motion of said handle.

17. A heated handle construction as recited by claim 1, wherein said power source comprises a plurality of batteries.

18. A heated handle construction as recited by claim 17, wherein said batteries are lithium ion batteries.

19. A heated handle construction as recited by claim 1, wherein said integral heating element is a wound flexible tape.

20. A heated handle construction as recited by claim 1, wherein said integral heating element is a wound flexible strip.

21. A heated handle construction as recited by claim 1, wherein said integral heating element is a resistance wire.

22. A heated handle construction as recited by claim 21, wherein said resistance wire is a nickel-chromium resistance wire, a non-magnetic alloy of nickel and chromium.

23. A heated handle construction as recited by claim 22, wherein said nickel-chromium resistance wire is wound into coils.

24. A heated handle construction as recited by claim 1, wherein said integral heating element is a nickel-chromium resistance ribbon.

25. A heated handle construction as recited by claim 1, wherein an infrared reflective membrane or foil is inserted between said integral heating element and said insulating material of said handle.

26. A heated handle construction as recited by claim 25, wherein said infrared reflective membrane or foil is a metallic foil.

27. A heated handle construction as recited by claim 25, wherein said infrared reflective membrane or foil is a metallized polymeric sheet.

28. A heated handle construction as recited by claim 1, wherein a thermally insulating flexible foam tape is inserted between said thermally insulating material of said handle and said integral heating element to thereby provide a cushioned grip on said handle.

29. A heated handle construction as recited by claim 28, wherein an infrared reflective membrane or foil is inserted between said integral heating element and said thermally insulating flexible foam tape.

30. A heated handle construction as recited by claim 1, wherein said power source comprises batteries have an open circuit voltage of at least 12 V and being chargeable from a cigarette lighter connection in a car or SUV.

31. A heated handle construction as recited by claim 1, wherein said on-off switch additionally comprises 50% and 100% power settings.

32. A heated handle construction as recited by claim 1, wherein said handle is a finger grooved handle.

33. A heated handle construction as recited by claim 1, wherein said handle is a “J” curved handle.

34. A heated handle construction as recited by claim 1, wherein said handle is a straight handle.

35. A heated handle construction as recited by claim 1, wherein said handle is a semi “U-shaped” bar.

36. A heated handle construction as recited by claim 1, wherein said integral stem portion is part of a walking aid, including a cane, walking stick and polio sticks.

37. A heated handle construction as recited by claim 1, wherein said integral stem portion is constructed as an inverted U-shape having parallel legs to form a walker device or crutches.

38. A heated handle construction as recited by claim 1, wherein said integral stem portion is part of a snow shovel or ice-scraper.

39. A heated handle construction as recited by claim 1, wherein said integral stem portion is mounted on a stroller, baby carriage, or baby pram.

40. A heated handle construction as recited by claim 1, wherein said integral stem portion is mounted on sport equipment, including golf clubs, fishing rods and hockey sticks.

41. A heated handle construction as recited by claim 1, wherein said integral stem portion mounted on animal leads, leashes and harness handles.

42. A heated handle construction as recited by claim 1, wherein said integral stem portion is mounted within knitting needles and crochet hooks.

43. A heated handle construction as recited by claim 1, wherein said integral stem portion is mounted within handicap equipment, including wheelchairs and crutches.

44. A heated handle construction as recited by claim 1, wherein said integral stem portion is mounted within vehicles, including bicycles, scooters, motor cycles and snow mobiles.

45. A heated handle construction as recited by claim 1, wherein said integral stem portion is mounted within hand tools, including chain saws, and construction tools.

46. A heated handle construction as recited by claim 1, wherein said outer layer of said handle portion is water proof and thereby resists accumulation and penetration of water on said handle portion and said heating element.

47. A heated handle construction as recited by claim 1, wherein said outer layer of said handle portion is composed of a polymeric material or mixture thereof.

48. A heated handle construction as recited by claim 1, wherein said outer layer of said handle portion is composed of a natural material, selected from a group consisting of wood, leather, shearling, suede, fur, or reptile skins.

49. A heated handle construction as recited by claim 1, wherein said outer layer of said handle portion is composed of a fabric, selected from a group consisting of wool, cashmere, blended knits, lycra, nylon, cotton or denim.

50. A heated handle construction as recited by claim 1, wherein said outer layer of said handle portion is composed of a foam or rubber product.

51. A heated handle construction as recited by claim 1, wherein said outer layer of said handle portion is composed of a metal.

52. A heated handle construction as recited by claim 1, wherein said outer layer of said handle portion is composed of a ceramic material.

53. A heated handle construction as recited by claim 1, wherein said outer layer of said handle portion is composed of a tourmaline material.

54. A heated handle construction for mounting on at least one device, comprising:
a. a thermally insulating material;
b. an outer layer;
c. integral heating elements to adjust said handle to a temperature level;
d. a retaining chamber for housing a power source in communication with an on-off switch for delivering power to said heating elements; and
e. mounting means for removable attachment of said handle to a proximal end of an integral stem portion of a first device, said stem portion further comprising a distal end and a central shaft, said proximal end comprising a handle attachment means appointed for mating engagement with said mounting means of said handle for mounting said handle on said integral stem portion;
whereby said handle is attached to said first device by way of said mounting means and is warmed efficiently to raise said handle to a temperature level that provides a comfortable grip for the user of said first device.

55. A heated handle construction as recited by claim 54, wherein said first device is an umbrella having a heated handle construction, comprising:
i. said integral stem portion further having a canopy portion, a spring member and a plurality of extension rods;
ii. said canopy having an external surface and an internal surface; and
iii. said external surface of said canopy being water repellent and thereby resisting saturation and shedding or facilitating said repellency of rain drops;
whereby said water repellent canopy prevents accumulation of water on said heated handle and said heated handle is warmed efficiently to provide said comfortable grip for said user.

56. A heated handle construction as recited by claim 54, wherein said handle comprises an internal compartment forming said retaining chamber for housing said power source so that said power source is retained within said handle.

57. A heated handle construction as recited by claim 54, wherein said central shaft of said stem portion of said device has a hollow cavity forming said retaining chamber for housing said power source therein.

58. A heated handle construction as recited by claim 54, wherein said outer layer of said handle is composed of a cloth or fibrous material comprising a primary layer and a secondary layer forming a dual layered cloth-like covering, and wherein said heating element is housed between said secondary and primary layers of said outer layer of said handle, wherein said cloth-like covering slides over an integrated handle element of said device.

59. A heated handle construction for mounting on at least one device, comprising:
a. a thermally insulating material;
b. an outer layer;
c. integral heating elements to adjust said handle to a temperature level;
d. a retaining chamber for housing a power source in communication with an on-off switch for delivering power to said heating elements; and
e. mounting means for removable attachment of said handle to a first device, said handle comprising a handle attachment means appointed for mating engagement with a mounting means of said handle for mounting said handle on said first device;
whereby said handle is attached to said first device by way of said mounting means and is warmed efficiently to raise said handle to a temperature level that provides a comfortable grip for the user of said first device.
